(19) United States
(12) Patent Application Publication
(10) Pub. No.: US 2007/0263177 A1
(43) Pub. Date: Nov. 15, 2007

(54) SYSTEM FOR DISPLAYING PICTURES IN REAR PROJECTION TELEVISION SET

(75) Inventors: Jurgen Kohler, Jena (DE); Jurgen Pudenz, Jena (DE); Gerd Reiche, Jena (DE); Eberhardt Piehler, Lehesten (DE); Ralph Mende, Jena (DE)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: SYPRO OPTICS GMBH, Jena (DE)

(21) Appl. No.: 11/677,716

(22) Filed: Feb. 22, 2007

(30) Foreign Application Priority Data
Feb. 24, 2006 (DE) 10 2006 008589.2

(51) Int. Cl. G03B 21/28

(52) U.S. Cl. 353/69; 353/77

(57) ABSTRACT

A system for displaying pictures in a rear projection television set including projection optics (2) disposed in the housing of the television set and connected to an illumination unit (1), with a picture transmitter (13) having a digital tilt mirror matrix (DMD matrix), the picture modulated by the picture transmitter (13) being projected by the projection optics (2) onto the rear side of a screen (7). The projection optics (2) include a first and second part optics (8, 9) lying on a common optical axis (11) that are provided at the same time for illumination. The light coming from the illumination unit passes via third part optics (10) and via at least one deflection element (15) into the second part optics (9). In the optical path of the front region of the projection optics an “off axis” mirror (5) and at least one deflection element (15) bend the optical path.

### CROSS-REFERENCE TO RELATED APPLICATION

This application claims priority from German Patent Application Serial No. 10 2006 008589.2, filed on Feb. 24, 2006.

### FIELD OF THE INVENTION

The invention relates to a system for displaying pictures in a rear projection television set comprising projection optics disposed in the housing of the television set and connected to an illumination unit, with a picture transmitter preferably consisting of a digital tilt mirror matrix (DMD matrix), the picture modulated by the picture transmitter being projected by the projection optics onto the rear side of a screen.

### BACKGROUND OF THE INVENTION

Known systems for displaying a picture using the rear projection method comprise, as well as a projection system, various optical deflection elements for changing the position of the axis of the optical path of the image in order to thus keep the housing depth as small as possible. This type of system is described, for example, in WO 2003040824 A1, EP 665460 B1 and U.S. Pat. No. 6,631,994 B2. The essential disadvantages of the known solutions are that a plurality of optical elements are required in order to minimize the apparatus depth so that the production costs of the individual elements and the fitting costs are very high.

### SUMMARY OF THE INVENTION

Starting with these disadvantages, the object which forms the basis of the invention is to further develop a system for displaying pictures in a rear projection television set to the effect that it is possible to minimize the structural depth of the apparatus with reduced costs.

This object is fulfilled according to the invention by a system of the type described at the start in that the projection optics consist of first and second part optics lying on a common optical axis, the second part optics are in the form of a field lens and are provided at the same time for illumination, the light coming from the illumination unit passes via third part optics lying at an angle α to the general or common optical axis of the first and the second part optics and via at least one deflection element into the second part optics, and in the optical path of the optical image system an “off axis” mirror and at least one deflection element serving to bend the optical path are provided.

For the purpose of minimizing the individual optical elements a possibility to be considered is coupling the picture transmitter with an electronic predistortion module which is connected to a control unit and a correction unit, this correction unit predistorting the pre-specified picture data such that non-linear distortion produced by the projection optics is fully compensated by the control unit so that the picture is practically free from distortion.

By means of the electronic compensation of the non-linear distortion of the projection optics, clearly reduced demands can be made of the projection optics, i.e. greater production tolerances are permissible. Furthermore, this means that the number of elements required can be reduced so that the expense is reduced with respect to conventional systems. Furthermore, due to the reduction in individual elements, the weight of the projection optics and so of the apparatus as a whole can be reduced.

At the same time, by reducing the number of individual elements it is possible to reduce the distance between the projection optics and the rear projection area, and this in turn is associated with a reduction in the structural depth of the apparatus.

Irrespective of this, a total optical distortion correction of the picture display dispensing with the electronic fault compensation is conceivable.

Due to the fact that the third part optics are in principle disposed between the first and the second part optics, a high level of compactness of the projection optics can be achieved.

Advantageously, this is achieved in particular if the angle α between the optical axis of the third part optics and the general or common optical axis of the first and the second part optics is chosen to be ≦90 degrees.

Due to the second part optics with positive refraction power and lying close to the picture transmitter, the projection optics can be designed more compactly so that in particular the following optical elements can have a smaller diameter.

Furthermore, in the optical path of the projection optics, an “off axis” mirror and at least one deflection element serving to bend the optical path are provided.

One advantageous embodiment of the system according to the invention consists of the illumination unit being disposed such that its optical axis extends parallel to the housing floor of the television set. On the one hand this increases the life of the lamp, and on the other hand, by means of this installation position, manageability is substantially improved when changing the lamp.

It is wise for the deflection elements provided to bend the optical path of the image to be in the form of deflection mirrors, a first deflection mirror being located between the first part optics and the front region of the projection optics, a second deflection mirror being disposed between the front region of the projection optics and the “off axis” mirror, and a third deflection mirror being fixed between the “off axis” mirror and the screen.

One advantageous embodiment of the system consists of coupling the deflection mirror disposed between the first part optics and the front region of the projection optics with an actuator used for the purpose of blurring the pixel structure on the screen and applying oscillation movements. The main reason for using an actuator is to reduce costs by halving the area (halving the number of pixels), at the same time maintaining the resolution perceived.

For the purpose of minimizing the distance between the screen and the rear wall of the housing, a possible embodiment variation can be conceived such that the position of the optically effective areas of the deflection mirrors serving to bend the optical path of the image and the optical axis of the front region of the projection optics are defined by angles β—approx. 14 degrees, χ—approx. 28 degrees and δ—approx. 28 degrees, β being the angle between the deflection mirror for bending the optical path onto the “off axis” mirror and on the vertical plane of the screen, χ being the angle between the “off axis” mirror and the vertical plane of the screen, and δ being the angle between the optical axis of the front region of the projection optics and the plane of the housing floor.

Due to the picture display by means of the projection optics consisting of three part optics and the “off axis” mirror disposed in the optical path of the optical image system, a compactness of the rear projection picture display is achieved which leads to far smaller structural depths of a television set. This effect is further reinforced by a possible combination of the system with the electronic predistortion module, i.e. by the deliberate generation of distortion faults which, by means of the image optics, leads once again to a distortion-free picture display.

These and other features, advantages, and objects of the present invention will be further understood and appreciated by those skilled in the art by reference to the following specification, claims, and appended drawings.

### BRIEF DESCRIPTION OF THE DRAWINGS

In the following, the invention is described in greater detail by means of an exemplary embodiment. The same reference numbers in the individual figures indicate the same elements. In detail, these show as follows:

FIG. 1 is a simplified, schematic representation of the system;

FIG. 2 is a schematic representation of the projection optics (view A);

FIG. 3 is a schematic representation of the projection optics (view B); and

FIG. 4 is a schematic representation of the projection optics (view C).

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENT

Before describing in detail embodiments that are in accordance with the present invention, it should be observed that the embodiments reside primarily in combinations of apparatus components related to a system for displaying pictures in a rear projection television set. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

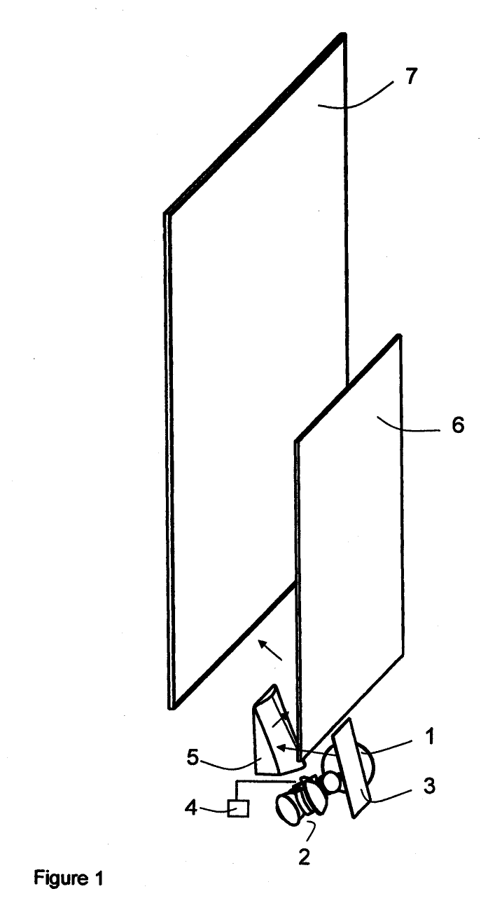

FIG. 1 shows the structure of the system according to the invention with an illumination unit 1, projection optics 2, a deflection mirror 3 serving to bend the optical path of the image, a schematically shown predistortion module 4, and an “off axis” mirror 5 disposed in the optical path of the image and which projects a picture coming from the deflection mirror 3 via a further deflection mirror 6 onto the screen 7 of the television set.

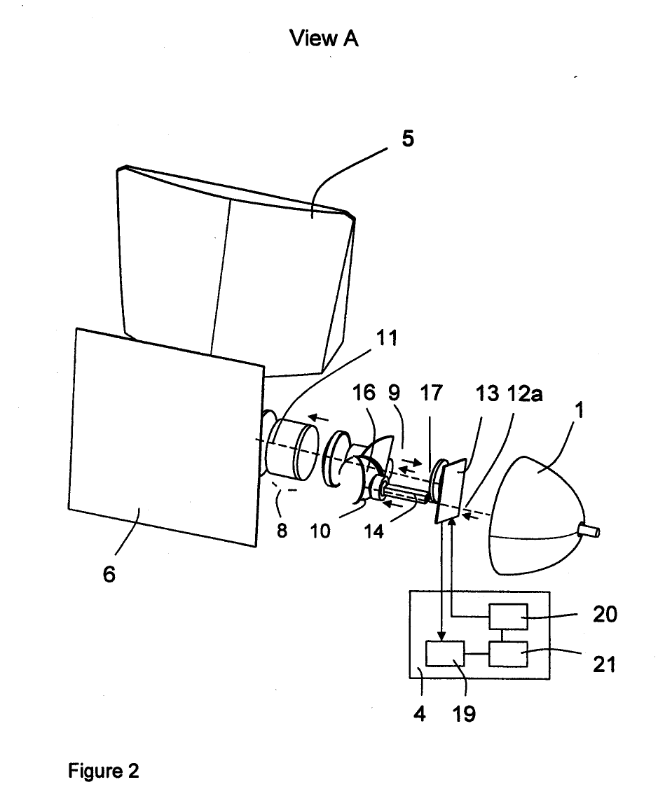

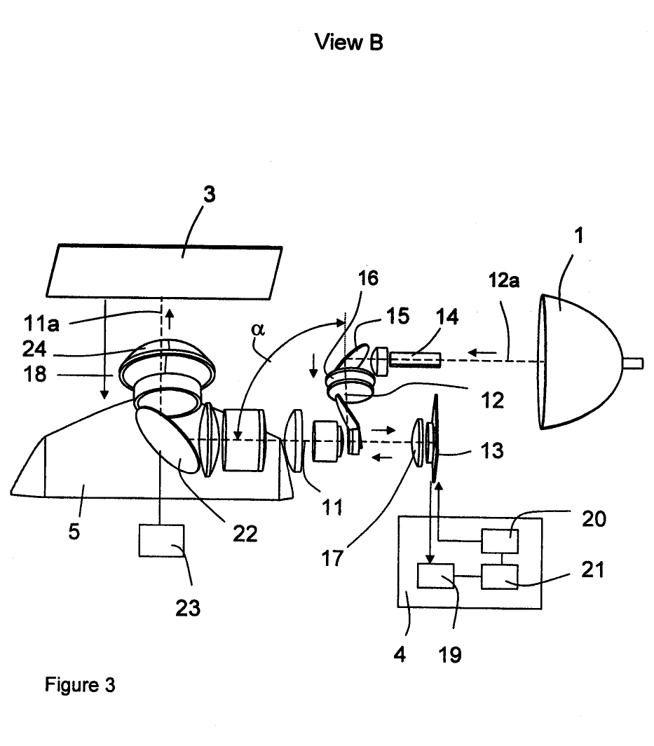

FIG. 2 partially shows (view A) the more detailed structure of the projection optics 2 consisting of first part optics 8, second part optics 9 (field lens) and third part optics 10. The first part optics 8 and the second part optics 9 are located on a common optical axis 11 here, whereas the optical axis 12 of part optics 3 form an angle α=90 degrees with the optical axis 11, as can be seen in FIG. 3.

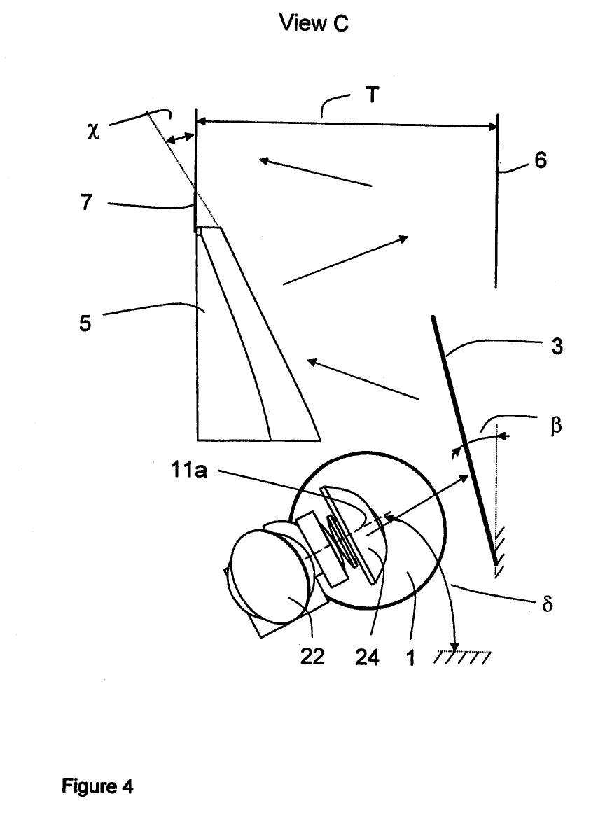

A picture transmitter 13 in the form of a DMD matrix is illuminated by the illumination unit 1, the light passing along the optical axis 12a through an integrator 14 via a bent “relay system” 16 provided with a deflection mirror 15 and through a field lens 17 onto the picture transmitter 13. An embodiment variation corresponding to the DMD matrix used with illumination from the side or from below is possible here. After the modulation in association with the deliberate predistortion by means of the predistortion module 4, the picture passes from the picture transmitter 13 via the part optics 8 and 9 and a further deflection mirror 22, through the front region 18 of the projection optics 2 and the deflection mirror 3 onto the “off axis” mirror 5. By means of further deflection (FIG. 4) by means of the deflection mirror 6, the picture is projected onto the screen 7.

The deliberate setting of the predistortion of the picture modulated on the picture transmitter 13 is implemented by an electronic unit 19 which is connected to a control unit 20 and a correction unit 21, the correction unit 21 predistorting the pre-specified picture data such that the non-linear distortion produced by the projection optics 2 is compensated by the control unit 20.

From the illustration according to FIG. 3 (view B), in order to bend the optical path of the image further a deflection mirror 22 is used which is coupled to an actuator 23 for applying oscillation movements. The actuator 23 serves to blur the pixel structure on the screen. This blurring is necessary in particular if picture transmitters are used with a pixel structure with which the pixels are interleaved with one another line by line so that more pixels are perceived by the observer. An aspherically formed front lens 24 lying on the optical axis 11a serves here to focus the projection optics 2.

FIG. 4 shows a view C of the system according to the invention from which, observing a defined bend in the optical path, a minimized housing depth T of approx. 170 mm can be achieved. One possibility for obtaining this housing depth T is achieved by observing the following angles:
β—approx. 14 degrees,
χ—approx. 28 degrees, and
δ—approx. 28 degrees,

β being the angle between the deflection mirror 3 for bending the optical path onto the “off axis” mirror 5 and on the vertical plane of the screen 7, χ being the angle between the “off axis” mirror 5 and the vertical plane of the screen 7, and δ being the angle between the optical axis 11a of the front region of the projection optics 2 and the plane of the housing floor.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1 A system for displaying pictures in a rear projection television set comprising:
a housing for the television set;
an illumination unit in the housing;
projection optics disposed in the housing and connected to the illumination unit, wherein the projection optics includes a picture transmitter having a digital tilt mirror matrix that modulates the picture being projected by the projection optics onto a rear side of a screen of the television set, a first part optics and a second part optics positioned on a common optical axis for illumination, and a third part optics for passing light from the illumination unit at a predetermined angle (α) to the common optical axis of the first and the second part optics; and
at least one deflection element, wherein light from the illumination unit passes via the third part optics and the at least one deflection element into the second part optics and in an optical path of a front region of the projection optics where an “off axis” mirror and the at least one deflection element bends the optical path.

2. A system for displaying pictures in a rear projection television set according to claim 1, wherein the picture transmitter is connected to an electronic predistortion module.

3. A system for displaying pictures in a rear projection television set according to claim 2, wherein the predistortion module is connected to a control unit and a correction unit where the correction unit predistorts the pre-specified picture data such that non-linear distortion produced by the projection optics is compensated by the control unit.

4. A system for displaying pictures in a rear projection television set according to claim 1, wherein the angle α between the optical axis of the third part optics and the common optical axis of the first and the second part optics is less than or equal to 90 degrees.

5. A system for displaying pictures in a rear projection television set according to claim 1, wherein a field lens is disposed in front of the picture transmitter in the second part optics.

6. A system for displaying pictures in a rear projection television set according to claim 1, wherein an optical axis of the illumination unit extends parallel to the housing floor of the television set.

7. A system for displaying pictures in a rear projection television set according to claim 1, wherein the deflection elements provided to bend the optical path of the image are deflection mirrors, a first deflection mirror being located between the first part optics and the front region of the projection optics, a second deflection mirror being disposed between the front region of the projection optics and the “off axis” mirror, and a third deflection mirror being fixed between the “off axis” mirror and a screen.

8. A system for displaying pictures in a rear projection television set according to claim 7, wherein the deflection mirror disposed between the first part optics and the front region of the projection optics is coupled to an actuator that applies oscillation movements for blurring the pixel structure on the screen.

9. A system for displaying pictures in a rear projection television set according to claim 7, wherein the depth (T) between the screen and the rear wall of the housing is minimized, and the position of the optically effective areas of the deflection mirrors that bend the optical path of the image and the optical axis of the front region of the projection optics are defined by angles β—approximately 14 degrees, χ—approximately 28 degrees, and δ approximately 28 degrees where β being the angle between the deflection mirror for bending the optical path onto the “off axis” mirror and on the vertical plane of the screen, χ is the angle between the “off axis” mirror and the vertical plane of the screen, and δ is the angle between the optical axis of the front region of the projection optics and the plane of the housing floor.

10. A system for displaying pictures in a rear projection television set comprising:
a housing for the television set;
an illumination unit in the housing;
projection optics disposed in the housing and connected to the illumination unit, wherein the projection optics includes a picture transmitter having a DMD matrix that modulates the picture being projected by the projection optics onto a rear side of a screen of the television;
an electronic predistortion module connected to the picture transmitter;
first and second part optics of the projection optics, wherein the first and second part optics lay on a common optical axis for illumination;
a third part optics of the projection optics, wherein the light coming from the illumination unit passes via the third part optics that is at an angle less than or equal to 90 degrees to the common optical axis of the first and the second part optics; and
at least one deflection element for deflecting light from the illumination unit to the second part optics in an optical path of a front region of the projection optics where an “off axis” mirror and the at least one deflection element bend the optical path.

11. The system for displaying pictures in a rear projection television set according to claim 10, wherein the predistortion module is an electronic unit which is connected to a control unit and a correction unit where the correction unit predistorts the pre-specified picture data such that non-linear distortion produced by the projection optics is compensated by the control unit.

12. The system for displaying pictures in a rear projection television set according to claim 10, wherein a field lens is disposed in front of the picture transmitter in the second part optics.

13. The system for displaying pictures in a rear projection television set according to claim 10, wherein an optical axis of the illumination unit extends parallel to the housing floor of the television set.

14. The system for displaying pictures in a rear projection television set according to claim 10, wherein the deflection elements provided to bend the optical path of the image are deflection mirrors, a first deflection mirror being located between the first part optics and the front region of the projection optics, a second deflection mirror being disposed between the front region of the projection optics and the “off axis” mirror, and a third deflection mirror being fixed between the “off axis” mirror and the screen.

15. The system for displaying pictures in a rear projection television set according to claim 14, wherein the deflection mirror disposed between the first part optics and the front region of the projection optics is coupled to an actuator that applies oscillation movements that blur the pixel structure on the screen.

16. The system for displaying pictures in a rear projection television set according to claim 14, wherein the depth (T) between the screen and the rear wall of the housing is minimized, and the position of the optically effective areas of the deflection mirrors that bend the optical path of the image and the optical axis of the front region of the projection optics are defined by angles β—approximately 14 degrees, χ—approximately 28 degrees, and δ approximately 28 degrees where β is the angle between the deflection mirror for bending the optical path onto the “off axis” mirror and on the vertical plane of the screen, χ is the angle between the “off axis” mirror and the vertical plane of the screen, and δ is the angle between the optical axis of the front region of the projection optics and the plane of the housing floor.

17. A system for displaying pictures in a rear projection television set comprising:
a housing for the television set;
an illumination unit in the housing, wherein an optical axis of the illumination unit extends substantially parallel to a floor of the housing;
projection optics disposed in the housing and connected to the illumination unit, wherein the projection optics includes a picture transmitter having a digital tilt mirror matrix (DMD matrix) that modulates the picture being projected by the projection optics onto a rear side of a screen of the television;
an electronic predistortion module connected to the picture transmitter, wherein the electronic predistortion module is an electronic unit that is connected to a control unit and a correction unit and further where the correction unit predistorts the pre-specified picture data such that non-linear distortion produced by the projection optics is compensated by the control unit;
first part optics and second part optics of the projection optics for providing illumination, wherein the first and second part optics lay on a common optical axis and the second part optics include a field lens in front of the picture transmitter;
a third part optics of the projection optics, wherein light coming from the illumination unit passes via the third part optics at an angle less than or equal to 90 degrees to the common optical axis of the first part optics and the second part optics; and
at least one deflection element, wherein light from the illumination unit passes via the third part optics and the at least one deflection element into the second part optics and in an optical path of a front region of the projection optics where an “off axis” mirror and the at least one deflection element bend the optical path.

18. The system for displaying pictures in a rear projection television set according to claim 17, wherein the deflection elements provided to bend the optical path of the image are deflection mirrors, a first deflection mirror being located between the first part optics and the front region of the projection optics, a second deflection mirror being disposed between the front region of the projection optics and the “off axis” mirror, and a third deflection mirror being fixed between the “off axis” mirror and the screen.

19. The system for displaying pictures in a rear projection television set according to claim 18, wherein the deflection mirror disposed between the first part optics and the front region of the projection optics is coupled to an actuator that applies oscillation movements that blur the pixel structure on the screen.

20. The system for displaying pictures in a rear projection television set according to claim 18, wherein the depth (T) between the screen and the rear wall of the housing is minimized, and the position of the optically effective areas of the deflection mirrors that bend the optical path of the image and the optical axis of the front region of the projection optics are defined by angles β—approximately 14 degrees, χ—approximately 28 degrees, and δ approximately 28 degrees, where β is the angle between the deflection mirror for bending the optical path onto the “off axis” mirror and on the vertical plane of the screen, χ is the angle between the “off axis” mirror and the vertical plane of the screen, and δ is the angle between the optical axis of the front region of the projection optics and the plane of the housing floor.
